(19) United States
(12) Patent Application Publication
(10) Pub. No.: US 2026/0140344 A1
(43) Pub. Date: May 21, 2026

(54) METHOD AND APPARATUS FOR IDENTIFYING A SPECIFIC NETWORK FIBER CABLE

(71) Applicant: Amphenol Network Solutions, Inc., Liberty Lake, WA (US)

(72) Inventors: Bryan Joseph Kioski, Spokane, WA (US); Craig Dwayne Ray, Raleigh, NC (US); Harley John McAllister, Liberty Lake, WA (US)

(21) Appl. No.: 19/394,411

(22) Filed: Nov. 19, 2025

Related U.S. Application Data
(60) Provisional application No. 63/722,400, filed on Nov. 19, 2024.

(51) Int. Cl. G02B 6/44; G02B 6/38

(52) U.S. Cl. CPC G02B 6/44528; G02B 6/3893; G02B 6/4453

(57) ABSTRACT

A data communication apparatus includes a tray including a connection management bay sized to accommodate a plurality of multi-fiber cables, a first retaining mechanism configured for holding the one or more data fibers connected via one or more splices or one or more connectors, and a second retaining mechanism disposed adjacent to a front surface of the tray. The second retaining mechanism is configured for holding the tracing fiber adjacent to the front surface whereat light is receivable and light is projectable from a remote lighting device to visually identify a connection origin of the tracing fiber.

### CROSS-REFERENCE TO RELATED APPLICATIONS

This application claims priority to U.S. Provisional Patent Application No. 63/722,400, filed on Nov. 19, 2024, entitled “METHOD AND APPARATUS FOR IDENTIFYING A SPECIFIC NETWORK FIBER CABLE,” which is incorporated in its entirety by reference.

### BACKGROUND

When an Optical Distribution Frame (ODF) is fully populated with connected fiber from one equipment frame to another, it can be difficult and cumbersome to identify, trace, and locate the opposite end connections, ensuring that each fiber is terminated in the proper location. When routing hundreds, or frequently thousands, of fiber terminations and the associated lengths of fiber that are essentially identical in appearance, it is difficult to quickly identify and ensure that the opposite ends of the respective fibers are terminated at the correct locations and positions, respectively.

### DETAILED DESCRIPTION OF THE DRAWINGS

The detailed description is set forth with reference to the accompanying figures. Furthermore, the drawings in the figures shown may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity. In the figures, the left-most digit(s) of a reference number identifies the figure in which the reference number first appears. The use of the same reference numbers in different figures indicates similar or identical items.

In this disclosure, the use of the term “component” may be substituted with other terms such as portion, feature, member, etc., any one of which may indicate a separate and distinct, but interconnected or interconnectable element, and/or may indicate merely a continuous aspect of a monolithic, integral unitary body.

Moreover, as used herein, terms such as “attached,” “fastened,” “secured,” “disposed,” “connected,” or “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate media, structures, mechanisms, or devices.

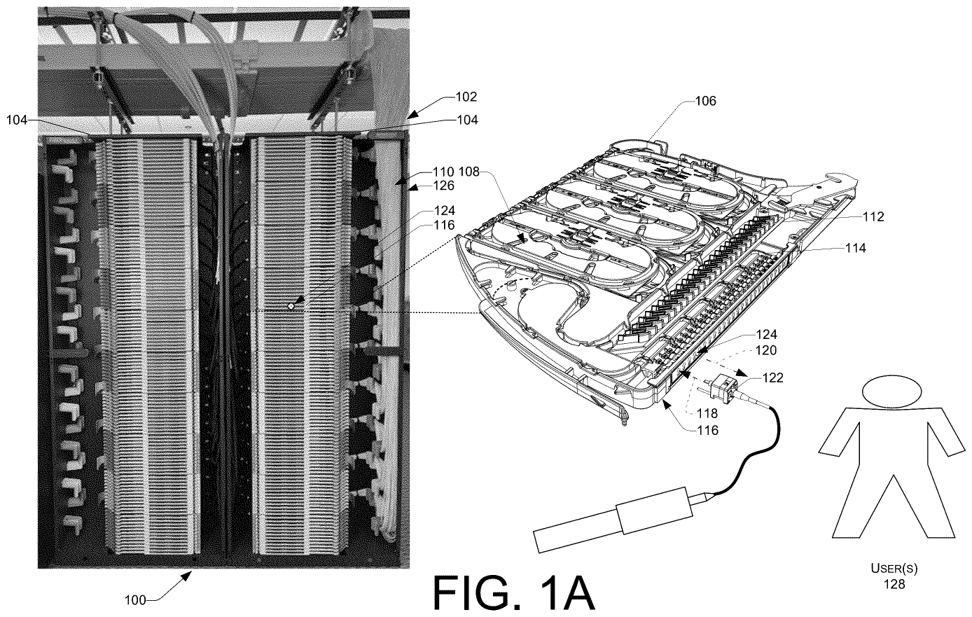

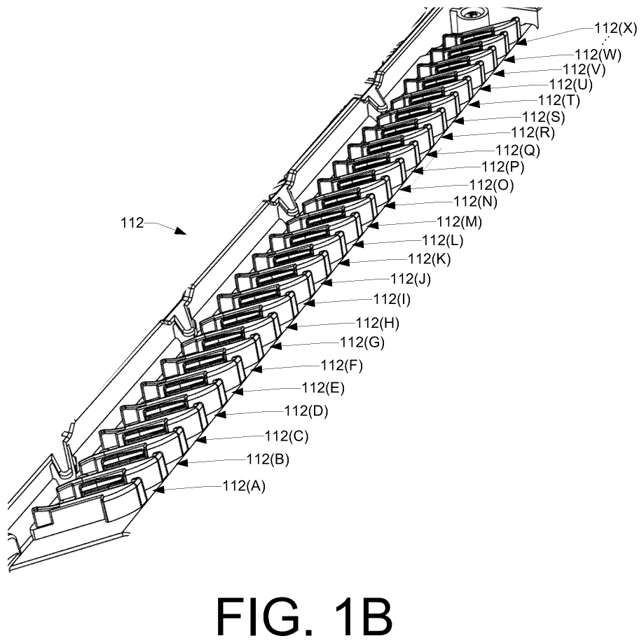

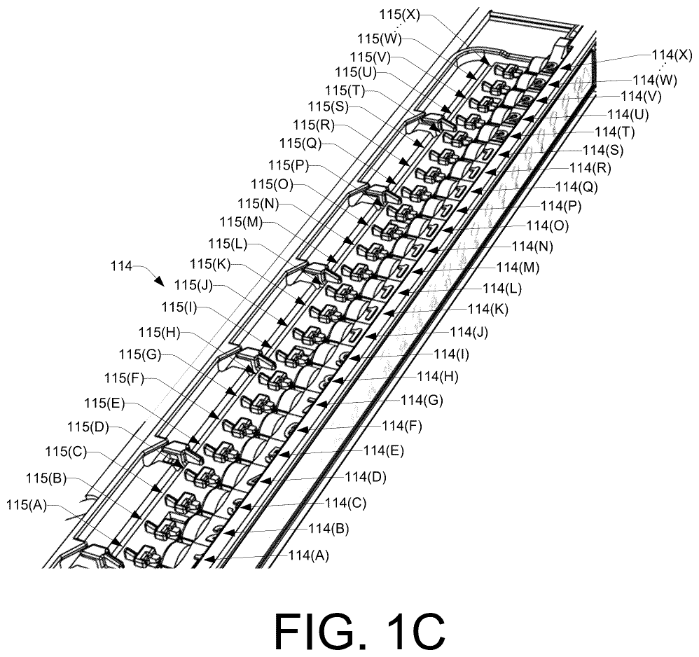

FIG. 1A illustrates a front view of an example data communication apparatus and a perspective view of a tray on which a user is tracing a fiber, according to an embodiment of this application.

FIG. 1B illustrates a perspective of an example first retaining mechanism of FIG. 1A, with additional detail, according to an embodiment of this application.

FIG. 1C illustrates a perspective view of a second retaining mechanism, according to an embodiment of this application.

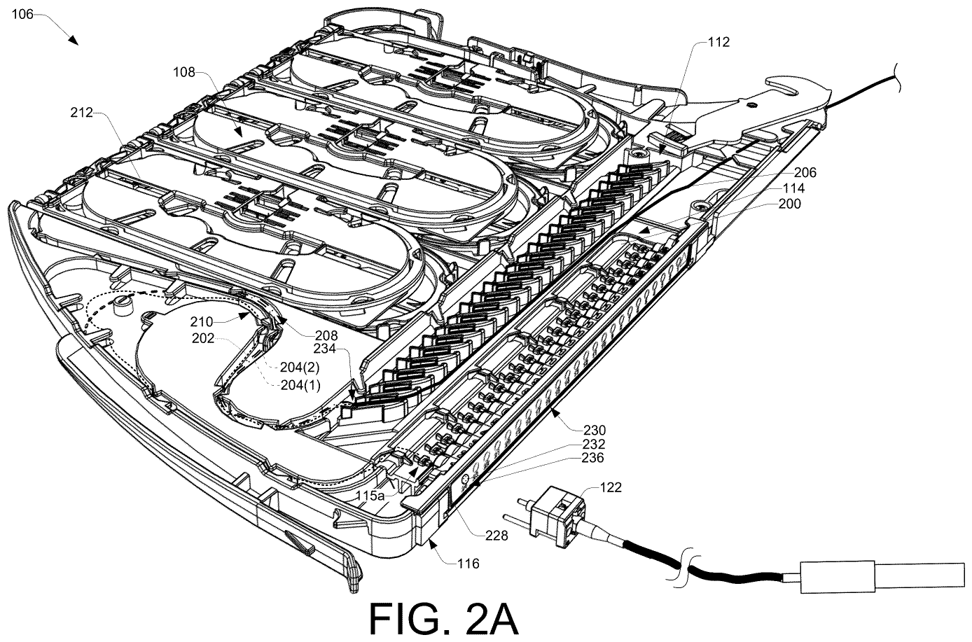

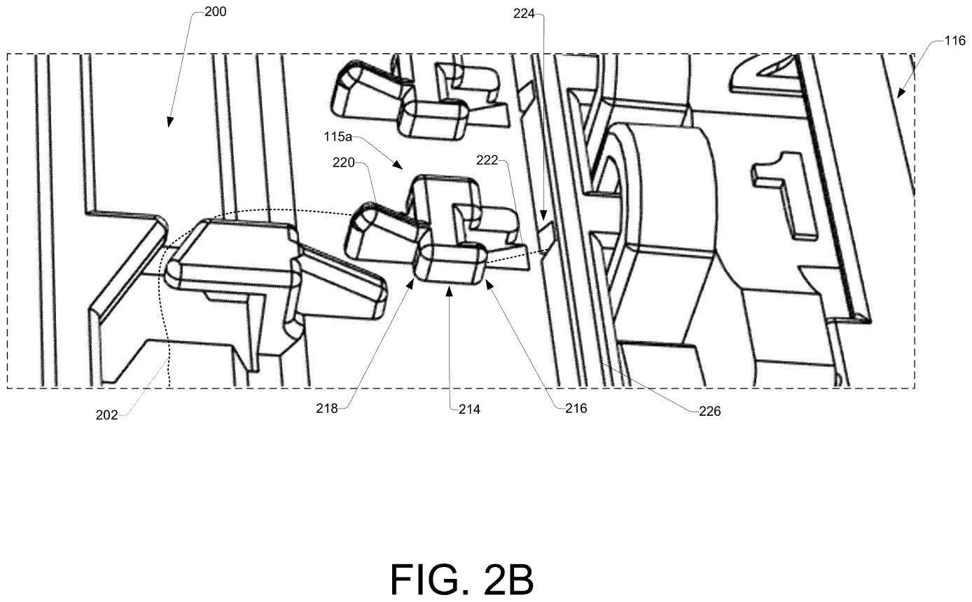

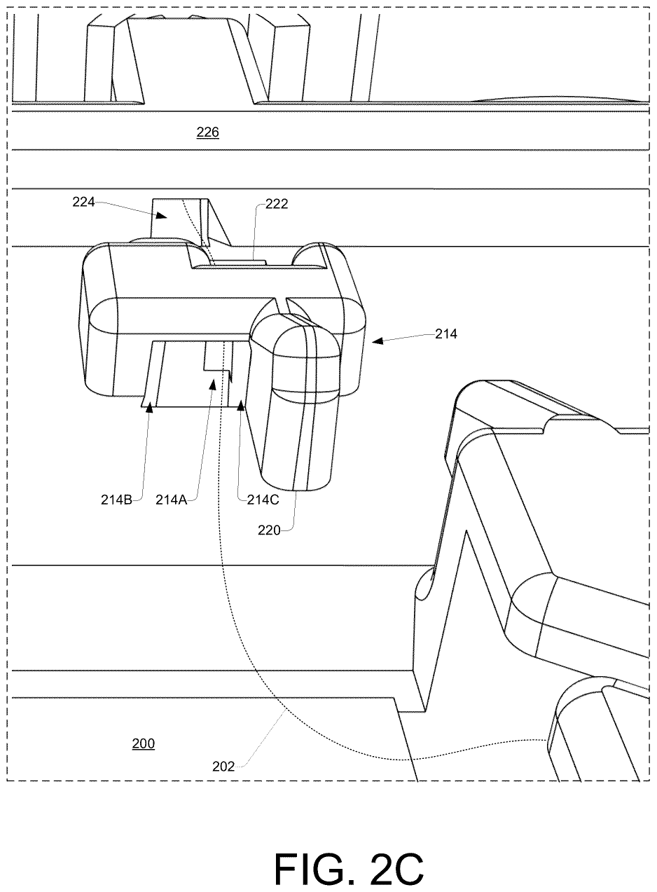

FIG. 2A illustrates, in isolation, the tray that may be implemented in the data communication apparatus of FIG. 1, according to an embodiment of this application.

FIG. 2B illustrates an enlarged detail side view showing a tracing fiber routed in a first tracing fiber channel, according to an embodiment of this application.

FIG. 2C illustrates an enlarged detail rear view showing a guide member that may define a funnel-shaped entry region adjacent to the first tracing fiber channel, according to an embodiment of this application.

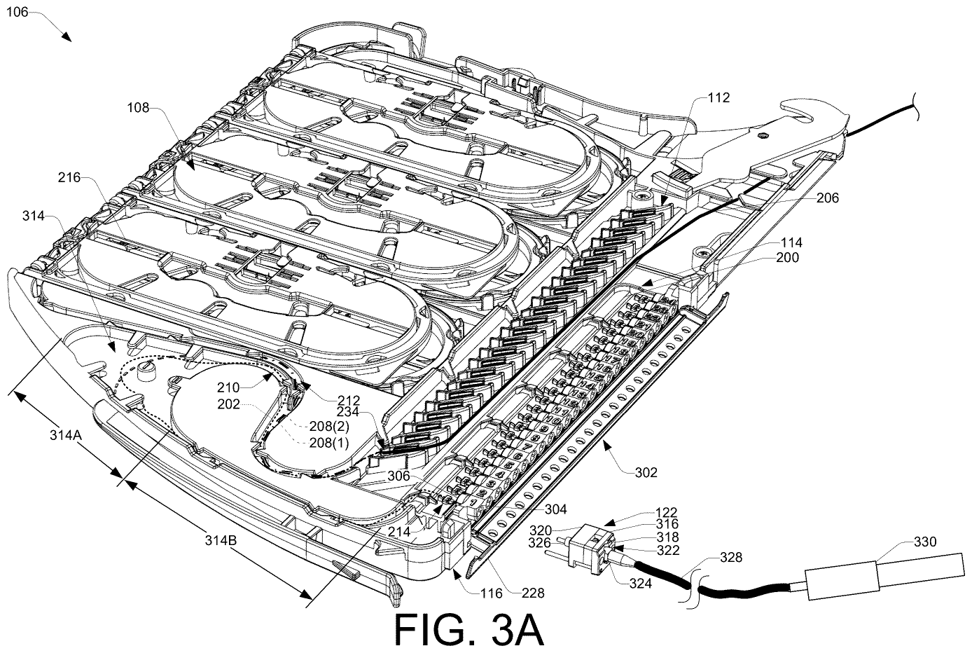

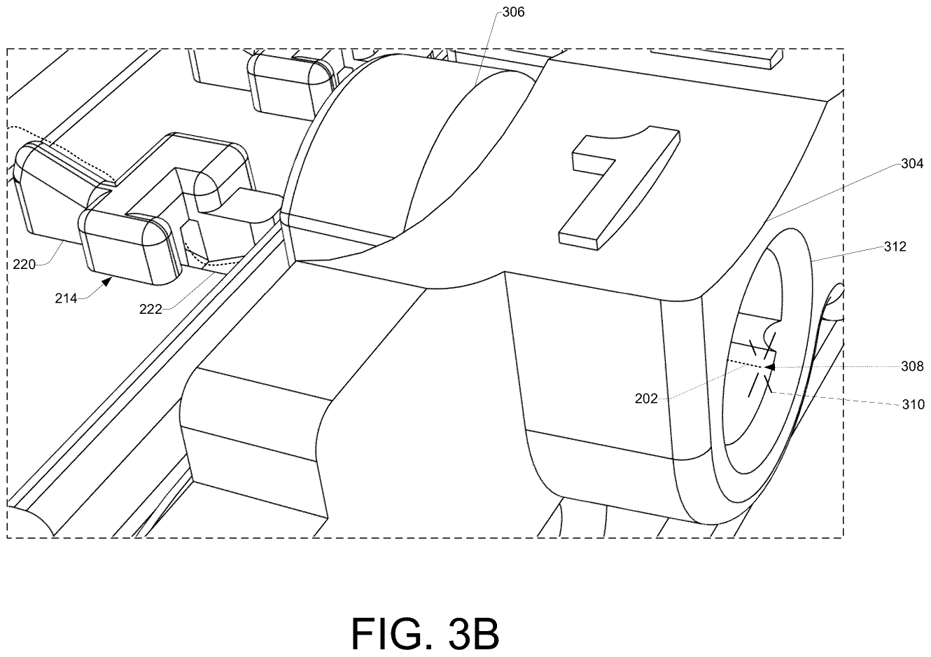

FIG. 3A illustrates the tray of FIG. 2A with an optical cover in an open position, according to an embodiment of this application.

FIG. 3B illustrates an enlarged detail view showing that the tracing fiber may be captured and held by a retention member, according to an embodiment of this application.

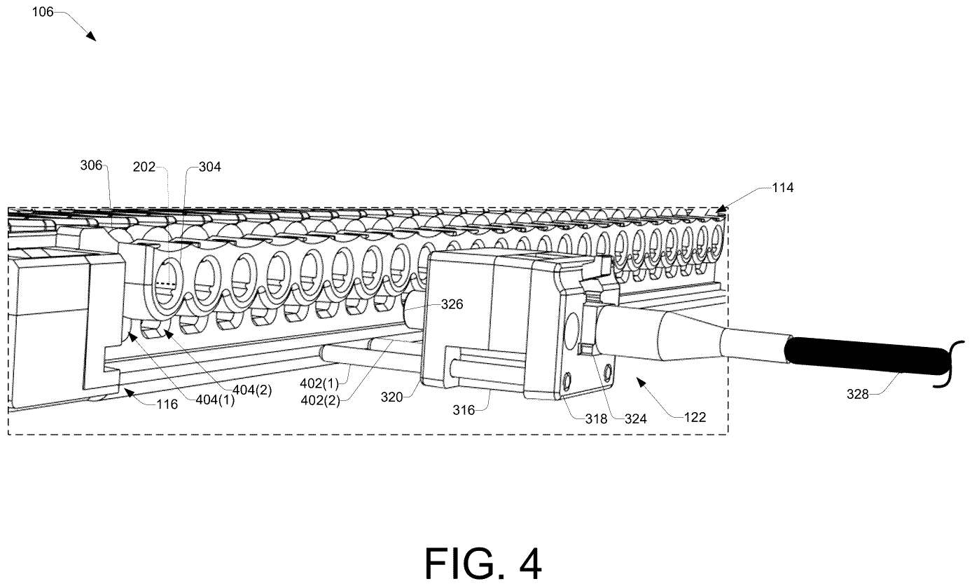

FIG. 4 illustrates an enlarged detail view of the front surface of the tray of FIG. 2A with an optical cover not shown for clarity, according to an embodiment of this application.

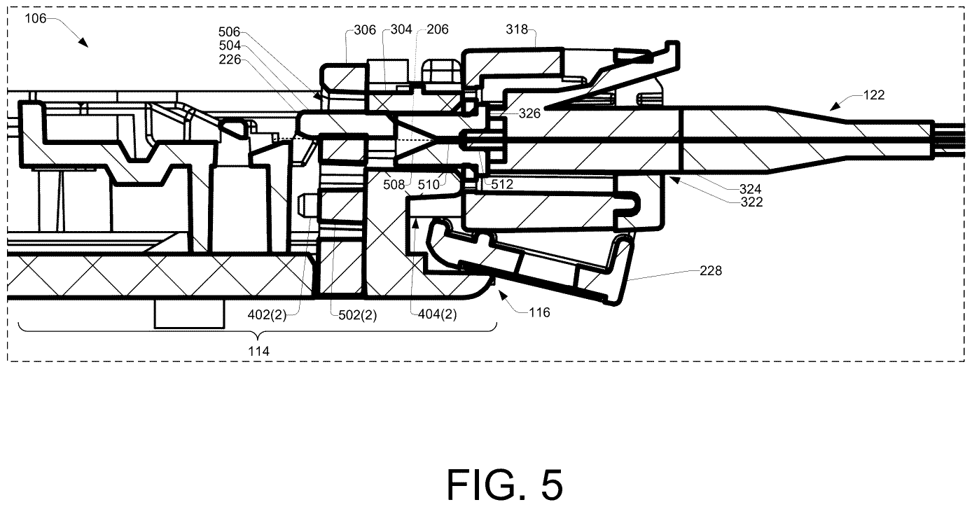

FIG. 5 illustrates a cross-section view of a remote lighting device removably coupled to a second retaining mechanism disposed adjacent to the front surface of the tray of FIG. 2A, according to an embodiment of this application.

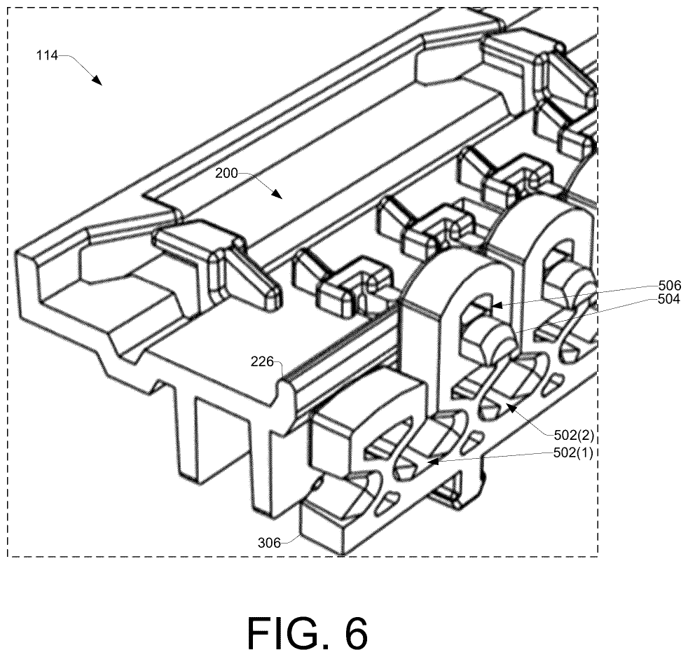

FIG. 6 illustrates a front, top perspective view of the second retaining mechanism (with optical ports not shown for clarity), according to an embodiment of this application.

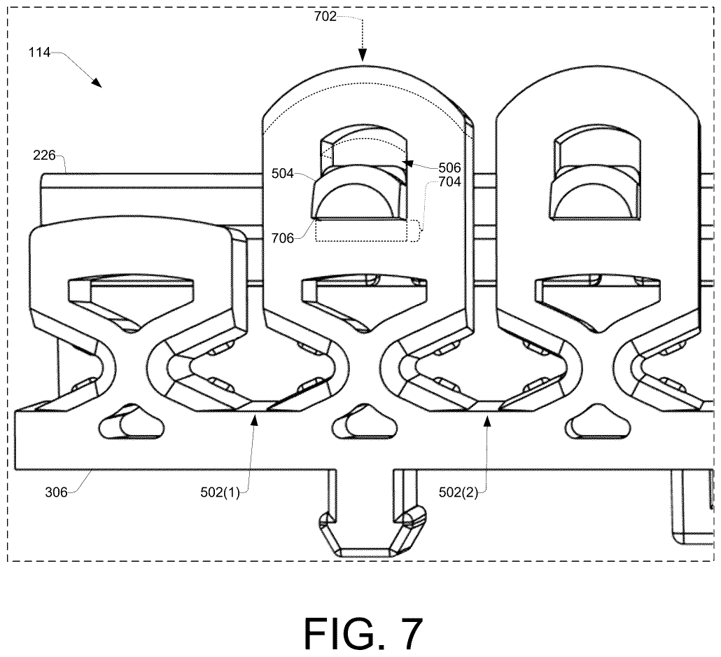

FIG. 7 illustrates an enlarged, front, left-side section view of a retaining mechanism (with optical ports not shown for clarity), according to an embodiment of this application.

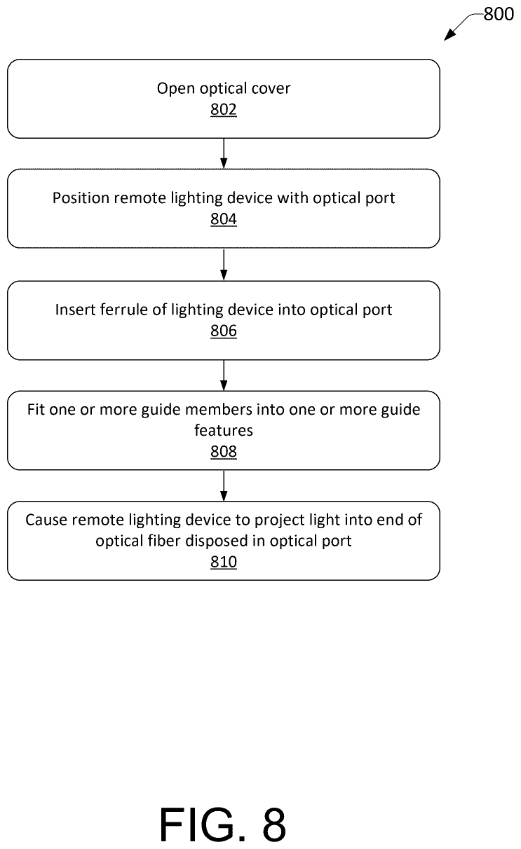

FIG. 8 illustrates a flowchart of an illustrative method of identifying a specific network cable within a frame of a data communication apparatus, or another connected frame, without accessing a tray, according to an embodiment of this application.

### DETAILED DESCRIPTION

### Overview

This disclosure is directed to a mechanism for tracing fiber connections across relatively short distances through a building from one location to another. Using a tracer fiber, a visual fault locator (VFL) or similar device, and visual indicators located on the front of the fiber panel, the connection origin of a fiber connection may be illuminated and the opposite end of the fiber connection and the location thereof are identifiable.

With such an arrangement of elements as mentioned above and explained in more detail below, this disclosure describes a “total front access” aspect which implies that a person may access and perform a task of tracing fiber connections (among other tasks) at a front-facing position of the fiber panel without disrupting live fiber or live adjacent fibers. That is, this solution does not require someone to disconnect, move, or disrupt fiber connections to employ the tracer feature, and further features visual indicators at the front of the fiber tray.

In an embodiment, a tray may include a connection management bay sized to accommodate a plurality of multi-fiber cables. At least one multi-fiber cable may include one or more data fibers and a tracing fiber. The tray may further include a first retaining mechanism configured for holding the one or more data fibers connected via one or more splices or one or more connectors. The first retaining mechanism may be disposed with the connection management bay.

The tray may further include a second retaining mechanism disposed adjacent to a front surface of the tray. The second retaining mechanism may be configured to hold the tracing fiber adjacent to the front surface, where light is receivable and light is projectable from a remote lighting device to visually identify the connection origin of the tracing fiber.

### Illustrative Data Communication Apparatuses

FIG. 1A depicts an example data communication apparatus 100 having fiber cable 102 routed therethrough. The data communication apparatus 100 may be a fiber vault, for example, having one or more frames 104 and a plurality of trays 106 disposed in the one or more frames 104. For example, in an embodiment using multi-fiber cables having at least two data fibers and one tracing fiber, the data communication apparatus 100 may have six trays per shelf unit with upwards of 48 splices per shelf and upwards of 5,760 fiber terminations when configured with a 288-fiber trunk cable. In another embodiment using multi-fiber cables having at least two data fibers and one tracing fiber, there may be upwards of 120 trays per frame with upwards of 2,880 tracing fibers disposed in front surfaces of the trays to provide for visual identification of any of the connection origins associated with upwards of 5,760 fiber splices. In another embodiment using multi-fiber cables having at least one ribbon fiber containing upwards of 16 data fibers and one tracing fiber, there may be upwards of 64 trays per frame with upwards of 36 tracing fibers disposed in front surfaces of the trays to provide for visual identification of any of the connection origins associated with upwards of 36,864 fibers. In another embodiment using multi-fiber cables having upwards of four ribbon fibers, each ribbon fiber containing upwards of 16 data fibers and one tracing fiber per cable, there may be upwards of 64 trays per frame with upwards of 9 tracing fibers disposed in front surfaces of the trays to provide for visual identification of any of the connection origins associated with upwards of 36,864 fibers. In an embodiment, the one or more frames 104 may include a door attached to a front side of the frame. The door may include a transparent portion such that the front surfaces of the trays 106 may be visible through the transparent portion to permit visual identification of the connection origins of the tracing fibers. When the tracing fibers are disposed in the front surfaces of the trays 106 as described here, the connection origins may be easily identifiable without having to open the data communication apparatus 100 and/or the trays 106. Accordingly, with a total front access situation as described herein, locating a circuit and/or troubleshooting a circuit within the frame 104 or in another connected frame may take less time, may be less labor intensive, and may be more cost-effective than is conventionally done by using existing options which include tracing fiber disposed in ends of connectors disposed inside of trays that require manual retrieval from the trays to be identified.

For the sake of clarity and simplicity, the following description will describe further details with respect to a tray 106 as a single tray of potentially many trays. Nevertheless, it is understood that all trays 106 may include similar or the same features as are described with respect to the single tray. As shown in FIG. 1A, the tray 106 may include a connection management bay 108 sized to accommodate a plurality of multi-fiber cables 110. In an embodiment, at least one multi-fiber cable of the plurality of multi-fiber cables 110 may include one or more data fibers and a tracing fiber. The tray 106 may further include a first retaining mechanism 112 configured to hold the one or more data fibers connected via one or more splices or one or more connectors. FIG. 1B depicts the first retaining mechanism 112 in isolation for clarity. As depicted, in an embodiment, the first retaining mechanism 112 may include a plurality of laterally adjacent, aligned slots 112a-112x, in which multi-fiber cable may be secured and routed (discussed in more detail later herein). In an embodiment, the one or more data fibers may include single mode fibers or multimode fibers, and the tracing fiber may include a single mode fiber or a multimode fiber. In another embodiment, the one or more data fibers may include at least two single mode fibers or the tracing fiber may include a multimode fiber. In an embodiment, the first retaining mechanism 112 may be disposed with the connection management bay 108.

FIG. 1A illustrates that tray 106 may include a second retaining mechanism 114 disposed adjacent to a front surface 116 of the tray 106. FIG. 1C illustrates the second retaining mechanism 114 in isolation for clarity. As depicted, in an embodiment, the second retaining mechanism may include a plurality of laterally adjacent, aligned optical ports 114a-114x, in which tracing fiber may be secured and routed (discussed in more detail later herein). The second retaining mechanism 114 may be configured to hold the tracing fiber adjacent to the front surface 116 in a position such that light is receivable 118 and light is projectable 120 from a remote lighting device 122 to visually identify a connection origin 124 of the tracing fiber. For example, as depicted in FIG. 1C, in an embodiment, the second retaining mechanism 114 may include a plurality of laterally adjacent, aligned fiber-guide features 115a-115x configured to receive, align, and retain an end portion of the tracing fiber along an optical axis of respective ones of the optical ports 114a-114x. In such a configuration, the optical axis is alignable with the remote lighting device 122 to project light through the tracing fiber for visually identifying a connection origin. In an embodiment, the optical ports 114a-114x of the second retaining mechanism 114 may be disposed in the front surfaces of the trays and the second retaining mechanism 114 may hold the tracing fibers in the optical ports 114a-114x whereat light is receivable 118 and light is projectable 120 from the remote lighting device 122. Further, when the tray 106 is disposed in the frame 104, the front surface 116 of the tray 106 may be disposed proximate to a front side 126 of the frame 104, providing easier viewing to identify the connection origin 124 of the tracing fiber from among thousands of connections and/or circuits. For example, a user 128 may locate a circuit and/or troubleshoot a circuit within the frame 104, or in another connected frame without accessing the tray 106, by using the remote lighting device 122 to project light into the front surface 116 of the tray 106 to visually identify a connection origin 124 of the tracing fiber.

FIG. 2A illustrates, in isolation, the tray 106 that may be implemented in the data communication apparatus 100 of FIG. 1. Inasmuch as FIG. 2A depicts the tray 106, while referring to the same elements and features, the following discussion of specific features may refer to FIGS. 1A, 1B, and 1C except where explicitly indicated. In particular, FIG. 2A illustrates an embodiment of the tray 106 including the connection management bay 108, the first retaining mechanism 112, the second retaining mechanism 114, and the front surface 116.

In an embodiment, the second retaining mechanism 114 may include a first tracing fiber channel 200. The first tracing fiber channel 200 may extend along a length of the second retaining mechanism 114 and is configured to accommodate a plurality of tracing fibers of a plurality of multi-fiber cables. As depicted, the first tracing fiber channel 200 may accommodate tracing fiber 202 (illustrated as a small dashed broken line) separated from one or more data fibers 204(1) and 204(2) (illustrated as two dot-dashed broken lines), all of which originate from a multi-fiber cable 206 of the plurality of multi-fiber cables 110. In an embodiment using multi-fiber cables having at least two data fibers and one tracing fiber, a user may route upwards of 24 respective multi-fiber cables 206 to upwards of 24 designated respective slots 112a-112x in the first retaining mechanism 112. In another embodiment using multi-fiber cables having one or more ribbon fibers, containing upwards of 16 data fibers in each ribbon fiber and one tracing fiber, a user may route upwards of 36 respective multi-fiber cables 206 to upwards of 36 designated respective slots 112a-112x in the first retaining mechanism 112. The multi-fiber cables 206 may be cut (ring cut) to expose the one or more data fibers (such as 204(1) and 204(2)) and the tracing fibers (such as 202) contained in the respective multi-fiber cables 206. While FIG. 2A illustrates two data fibers and a tracing fiber contained in the respective multi-fiber cables 206, one or more of the multi-fiber cables 206 may contain any number of data fibers along with the tracing fiber. For example, a respective multi-fiber cable may contain upwards of 16 data fibers (e.g., ribbon fiber containing upwards of 16 data fibers) being routed with the tracing fiber. In another example, a respective multi-fiber cable may contain upwards of 64 data fibers (e.g., single jacket containing upwards of 4 ribbon fibers, each ribbon fiber having upwards of 16 data fibers) being routed with the tracing fiber. The user may then route the one or more data fibers 204(1) and 204(2) and the tracing fibers 202 along a channel, including a slot (one of 112a-112x) of the first retaining mechanism 112, to a data fiber channel 208 and a second tracing fiber channel 210, respectively. That is, the data fibers 204(1) and 204(2) may be routed in the data fiber channel 208 and the tracing fibers 202 may be routed in the second tracing fiber channel 210. In an embodiment, the data fiber channel 208 may be kept separated from the second tracing fiber channel 210 via a mutual channel wall. The data fiber channel 208 and the second tracing fiber channel 210 may be fed directly next to each other.

The one or more data fibers 204(1) and 204(2) routed in the data fiber channel 208 may be routed to one or more bays 212 (e.g., splice bays, connector bays, etc.) disposed in the connection management bay 108 where the one or more data fibers 204(1) and 204(2) may be spliced and/or connected. The tracing fibers 202 routed in the second tracing fiber channel 210 may be routed to the first tracing fiber channel 200 of the second retaining mechanism 114 where each of the tracing fibers 202 may be individually routed to the front surface 116 of the tray 106.

For example, FIG. 2B illustrates an enlarged detail side view showing the tracing fiber 202 routed to the first tracing fiber channel 200 where the tracing fiber 202 is individually routed to the front surface 116 of the tray 106 via the fiber-guide feature 115a. In an embodiment, as depicted in FIG. 2B, the fiber-guide features 115a-115x may include a guide member 214 disposed with the first tracing fiber channel 200. The guide member 214 has a front portion 216 opposite a rear portion 218. The front portion 216 is disposed adjacent to the front surface 116 of the tray 106, and the rear portion 218 may be disposed adjacent to the first tracing fiber channel 200. The guide member 214 may include a guide wall 220 extending from the rear portion 218 toward the first tracing fiber channel 200. A guide ramp 222 may extend from the rear portion 218 through the guide member 214 to the front portion 216 of the guide member 214.

FIG. 2C illustrates an enlarged detail rear view showing the guide member 214 may define a funnel-shaped entry region 214a adjacent to the first tracing fiber channel 200. The funnel-shaped entry region 214a may laterally constrain and/or direct the tracing fiber 202 toward the optical port 114a. In an embodiment, the funnel-shaped entry region 214a may include a first angled wall plane 214b opposite a second angled wall plane 214c. The first angled wall plane 214b and the second angled wall plane 214c may be disposed at predetermined angles relative to an optical axis. The first angled wall plane 214b and the second angled wall plane 214c may form the funnel-shaped entry region 214a that directs the tracing fiber 202 toward the guide ramp 222. The funnel-shaped entry region 214a and guide ramp 222 may cooperate to center the tracing fiber 202 along the optical axis for insertion into the optical port 114a. The funnel-shaped region 214a may provide for reducing threading error during installation, for example. In an embodiment, a user may hold the tracing fiber 202 at least about 1 inch up to at most about 3 inches from the end of the tracing fiber 202 and guide the tracing fiber 202 along the guide wall 220 and into the funnel-shaped region 214a to feed the tracing fiber 202 into the guide ramp 222. The user may continue to feed the tracing fiber 202 into the guide ramp 222 and through a tracer feature hole 224 arranged in a lip 226 arranged along a length of the second retaining mechanism 114 to position the tracing fiber 202 adjacent to the front surface 116 whereat light is receivable and light is projectable from the remote lighting device 122 to visually identify a connection origin of the tracing fiber 202. In an embodiment, the funnel-shaped entry region 214a may provide for a user to reliably thread the optical fiber 202 into the tracer feature hole 224 with reduced misalignment.

In an embodiment, the tray 106 may include an optical cover 228. The optical cover 228 may be displaceably attached to the tray 106 between an open position and a closed position 230. As seen in FIG. 2A, when in the closed position 230, light is projectable from the remote lighting device 122 and into the optical cover 228 to visually identify a connection origin 232 (illustrated as stippled circular area) of the tracing fiber 202. The optical cover 228 may be an optical diffuser. For example, the optical cover 228 may include a material (e.g., plastic, glass, etc.) having a rough or frosted surface that redirects light in many directions and/or having microscopic particles or structures inside the material that scatter light internally. For example, the optical cover 228 may comprise a textured polycarbonate label disposed on a front of a faceplate of the optical cover 228. When in the closed position 230, the optical cover 228 may provide for protecting the tracing fibers adjacent to the front surface 116. For example, when in the closed position 230, the optical cover 228 may be disposed in front of ends of the tracing fibers disposed adjacent to the front surface to prevent the ends of the tracing fibers from coming into contact with any nearby objects that may damage the tracing fibers. Moreover, the optical cover 228 may provide for labelling and/or designating the tracing fibers adjacent to the front surface 116. For example, the optical cover 228 may include a label at each optical port designating each optical port to a respective tracing fiber. In an embodiment, the tray 106 may be configured to accommodate upwards of 24 multi-fiber cables and include a respective designated slot 234 for each of the 24 multi-fiber cables to be inserted therein. In an embodiment, the optical cover 228 may include a respective label 236 for each designated optical port for each tracing fiber of the 24 tracing fibers associated with each of the 24 multi-fiber cables. In another embodiment, the tray 106 may be configured to accommodate upwards of 36 multi-fiber cables and include a respective designated slot 234 for each of the 36 multi-fiber cables to be inserted therein. In an embodiment, the optical cover 228 may include a respective label 236 for each designated optical port for each tracing fiber of the 36 tracing fibers associated with each of the 36 multi-fiber cables. Thus, and as FIG. 2 illustrates, the multi-fiber cable 206 may be a first multi-fiber cable, the slot 234 may be a first slot designated for the first multi-fiber cable, the tracing fiber 202 may be a first tracing fiber designated for a first optical port, and the label 236 may be a first label designating the first optical port for first tracing fiber.

FIG. 3A depicts the tray 106 with the optical cover 228 in an open position 302. When the optical cover 228 is in the open position 302, light is projectable from the remote lighting device 122 into the tracing fiber to visually identify the connection origin of the tracing fiber 202. FIG. 3A illustrates the second retaining mechanism 114 may include an optical port 304. The optical port 304 may be disposed in the front surface 116 of the tray 106. For example, the second retaining mechanism 114 may include a respective optical port 304 disposed in the front surface 116 of the tray 106 for each respective tracing fiber 202 of each of the respective multi-fiber cables 206. Each of the optical ports 304 may be aligned with a respective guide member 214. For example, each of the optical ports 304 may be aligned with the guide ramp 222 of each of the guide members 214 of the second retaining mechanism 114.

In an embodiment, the second retaining mechanism 114 may include a retention member 306 disposed between the guide member 214 and the optical port 304. The retention member 306 may provide for selectively holding the tracing fiber 202 in the optical port 304. For example, as discussed above, a user may hold the tracing fiber 202 and guide the tracing fiber 202 along the guide wall 220 of the guide member 214 to feed the tracing fiber 202 into the guide ramp 222 and through the tracer feature hole 224 until the tracing fiber 202 butts up against the retention member 306. The user may open an aperture disposed in the retention member 306 via pressing down on top of the retention member 306. The user may then insert the tracing fiber 202 through the aperture disposed in the retention member 306 and position the tracing fiber 202 in the optical port 304 adjacent to the front surface 116. The user may then stop pressing down on the retention member 306 to capture and hold the tracing fiber 202 in the optical port 304. For example, FIG. 3B illustrates an enlarged detail view showing the tracing fiber 202 may be captured and held by the retention member 306 such that an end 308 of the tracing fiber 202 is disposed substantially at a centerline 310 of the optical port 304 and substantially at an end 312 of the optical port 304. The aperture disposed in the retention member 306 may be disposed in the retention member 306 such that when the user stops pressing down on the retention member, the aperture closes onto the tracing fiber 202 and holds the tracing fiber 202 substantially at the centerline 310 of the optical port 304. The user may adjust the location of the end 308 of the tracing fiber 202 relative to the end 312 of the optical port 304. For example, if the end 308 of the tracing fiber 202 is not substantially disposed at the end 312 of the optical port 304, then the user may depress down on the top of the retention member 306 to open the aperture in the retention member 306 and adjust (e.g., push and/or pull) the tracing fiber 202 to position the end 308 of the tracing fiber 202 substantially at the end 312 of the optical port 304.

Moreover, in an embodiment, the tray 106 may include a tracing fiber management bay 314 arranged with the second tracing fiber channel 210. The tracing fiber management bay 314 may be configured for storing at least an extra length of the tracing fiber 202. In an embodiment, the tracing fiber management bay 314 may include a slack-storage region 314a and a pull-back zone 314b. The slack-storage region 314a may be located between the second tracing fiber channel 210 and the pull-back zone 314b. The pull-back zone 314 may be located between the slack-storage region 314a and the first tracing fiber channel 200. The slack-storage region 314a and the pull-back zone 314b may provide a routing path that accommodates the extra length of the tracing fiber 202 such that the extra length of the tracing fiber 202 provides for adjusting the location of the end 308 of the tracing fiber 202 disposed in the optical port 304. For example, the slack-storage region 314a and the pull-back zone 314b may permit the tracing fiber 202 to be extended and subsequently retracted to remove slack after insertion into the optical port 304, thereby reducing strain and maintaining alignment with the optical port 304. In an example, a user may use at least a portion of the extra length of the tracing fiber 202 stored in the tracing fiber management bay 314 to position the end 308 of the tracing fiber 202 at the end 312 of the optical port 304. In another example, the extra length of the tracing fiber 202 stored in the tracing fiber management bay 314 may provide for cleaving the end 308 of the tracing fiber 202. For example, if the end 308 of the tracing fiber 202 is inadequate (e.g., damaged, poorly cleaved, incorrect angle, etc.), a user may use the extra length of the tracing fiber 202 to cleave the end 308 of the tracing fiber 202 and position the newly cleaved end of the tracing fiber 202 such that the newly cleaved end is disposed substantially at the centerline 310 of the optical port 304 and substantially at the end 312 of the optical port 304. A user may continue this process to install the remaining optical fibers in the remaining optical ports disposed in the second retaining mechanism 114.

FIG. 3A depicts the remote lighting device 122 may include an adapter 316. The adapter 316 may have a front surface 318 opposite a back surface 320. The adapter 316 may include a port 322 arranged in the front surface 318 configured for holding a fiber optic connector 324. For example, the adapter 316 may be a custom lucent connector (LC) adapter (e.g., custom LC simplex adapter), and the fiber optic connector 324 may be a standard LC connector (e.g., standard LC simplex connector) held in the port 322. The adapter 316 may include a ferrule 326 protruding from the back surface 320. The ferrule 326 may provide for inserting into the optical port 304 and guiding the tracing fiber 202 into the ferrule 326 to align the tracing fiber 202 with a center of a core of the fiber optic connector 324. The remote lighting device 122 may include a light source cable 328. For example, the remote lighting device 122 may include an LC patch cable, a subscriber connector (SC) patch cable, a ferrule connector (FC) patch cable, etc. The remote lighting device 122 may include a visual fault locator (VFL) 330. For example, the remote lighting device 122 may include a VFL 330 couplable to an end of the light source cable 328 couplable to the adapter 316.

FIG. 4 depicts an enlarged detail view of the front surface 116 of the tray 106 with the optical cover 228 not shown for clarity. FIG. 4 illustrates that the remote lighting device 122 may further include one or more guide members 402(1) and 402(2) protruding from the back surface 320 of the adapter 316. FIG. 4 illustrates that the second retaining mechanism 114 may include one or more guide features 404(1) and 404(2) arranged with the optical port 304. As depicted, in an embodiment, the one or more guide features 404(1) and 404(2) may comprise a plurality of laterally adjacent, curvilinear-shaped slots (e.g., oval-shaped slots) arranged with the optical ports 304. The one or more guide members 402(1) and 402(2) and the one or more guide features 404(1) and 404(2) may cooperate to guide the remote lighting device 122 into position with the optical port 304 such that light is projected from the remote lighting device 122 into the tracing fiber 202 to visually identify the connection origin of the tracing fiber 202. For example, a user may slide the ferrule 326 into the optical port 304 aligned with a circuit, while fitting the tracing fiber 202 into the ferrule 326 and fitting the one or more guide members 402(1) and 402(2) into the one or more guide features 404(1) and 404(2) associated with the optical port 304. In an embodiment, the retention member 306 disposed behind the optical ports 304 may include one or more openings (illustrated in FIG. 6) configured to receive and hold the one or more guide members 402(1) and 402(2). For example, the retention member 306 may include one or more openings disposed behind the one or more guide features 404(1) and 404(2) for removeably gripping the one or more guide members 402(1) and 402(2) and holding the remote lighting device 122 up against the optical port 304 disposed in the front surface 116 of the tray 106. FIG. 4 illustrates that each of the ports 304 may have the one or more guide features 404(1) and 404(2) disposed below each of the optical ports 304.

FIG. 5 depicts a cross-section view of the remote lighting device 122, removably coupled to the second retaining mechanism 114 disposed adjacent to the front surface 116 of the tray 106. The cross-sectional view may be taken along a centerline of the optical port 304. FIG. 5 illustrates a user may have displaced the optical cover 228 from the closed position 230 to the open position 302 to insert the ferrule 326 of the remote lighting device 122 into the optical port 304, while fitting the tracing fiber 202 into the ferrule 326 and fitting the one or more guide members 402(1) and 402(2) into the one or more guide features 404(1) and 404(2) associated with the optical port 304. Further, the user may have fitted one or more guide members 402(1) and 402(2) into one or more guide features 502(1) and 502(2) arranged in the retention member 306 (discussed in more detail below with regard to FIG. 6).

In an embodiment the second retaining mechanism 114 may include a finger member 504 extending from the lip 226 and through an opening 506 arranged in the retention member 306 (discussed in more detail below with regard to FIG. 6). When a user presses down on top of the retention member 306, at least a portion of the opening 506 arranged in the retention member 306 may be displaced down below a bottom surface of the finger member 504, allowing the tracing fiber 202 to pass therethrough and into the optical port 304. Subsequent to passing the tracing fiber 202 into the optical port 304, the user may stop pressing down on top of the retention member 306 such that the portion of the opening 506 arranged in the retention member 306 may be displaced up against the bottom surface of the finger member 504 thereby clamping the tracing fiber 202 between the bottom portion of the finger member 504 and the retention member 306.

In an embodiment, the ferrule 326 may include one or more chamfers 508. The one or more chamfers 508 may provide for guiding the tracing fiber 202 into one or more bores 510 of the ferrule 326 of the lighting device 122. The one or more bores 510 may extend through the ferrule 326 such that the tracing fiber 202 extends into the one or more bores 510, where the tracing fiber 202 may be aligned with a center of a core 512 of the fiber optic connector 324. In an embodiment, the core 512 of the fiber optic connector 324 may be spring loaded such that when the fiber optic connector 324 is inserted into the port 322 of the adapter 316, an end of the core 512 may butt up against an end surface of the one or more bores 510 substantially aligning the tracing fiber 202 with the core 512 of the fiber optic connector 324 for launching light from the lighting device 122 into the tracing fiber 202. In an embodiment, the ferrule 326 may be formed of metal (e.g., steel, stainless-steel, aluminum, brass, copper, etc.).

FIG. 6 depicts a front, top left-side portion perspective view of the second retaining mechanism 114 with the optical ports 304 not shown for clarity. FIG. 6 illustrates that the finger members 504 may extend from the lip 226 and through the openings 506 arranged in the retention member 306. In an embodiment, the finger members 504 may comprise protrusions extending from the lip 226. The protrusions may be formed integrally with the lip 226 and may have a flat bottom surface opposite a curvilinear-shaped top surface. FIG. 6 illustrates the one or more guide features 502(1) and 502(2) arranged in the retention member 306. The one or more guide features 502(1) and 502(2) may be arranged in the retention member 306 such that the one or more guide features 502(1) and 502(2) are associated with a respective opening 506. As discussed above with regard to FIG. 5, a user may fit the one or more guide members 402(1) and 402(2) of the remote lighting device 122 into the one or more guide features 502(1) and 502(2) arranged in the retention member 306. In an embodiment, the retention member 306 may be formed of an elastomer, and the one or more guide features 502(1) and 502(2) arranged in the retention member 306 may grip the one or more guide members 402(1) and 402(2) of the remote lighting device 122. For example, the one or more guide features 502(1) and 502(2) may provide for a friction fit, press fit, interference fit, etc. with the one or more guide members 402(1) and 402(2) when the one or more guide members 402(1) and 402(2) are inserted into the one or more guide features 502(1) and 502(2). Moreover, the one or more guide members 402(1) and 402(2) and the one or more guide features 502(1) and 502(2) may cooperate to guide the ferrule 326 of the remote lighting device 122 into the optical port 304 of the second retaining mechanism 114, facilitating fitting the tracing fiber 202 into the ferrule 326.

FIG. 7 illustrates an enlarged, front, left-side section view of the retaining mechanism 114 with the optical ports 304 not shown for clarity. FIG. 7 depicts that the finger members 504 may extend from the lip 226 and through the openings 506 arranged in the retention member 306. FIG. 7 illustrates that, in an embodiment, the one or more guide features 502(1) and 502(2) may be arranged in the retention member 306 such that the one or more guide features 502(1) and 502(2) are associated with a respective opening 506.

In an embodiment, when a user presses down 702 on top of the retention member 306 above the opening 506 (displacement of retention member 306 shown in dotted lines), at least a portion 704 of the opening 506 arranged in the retention member 306 may be displaced down below a bottom surface 706 of the finger member 504. In this way, and as discussed above, the retention member 306 may provide for selectively holding the tracing fiber 202 in the optical port 304. For example, a user may guide the tracing fiber 202 along the guide wall 220 of the guide member 214 to feed the tracing fiber 202 into the guide ramp 222 and through the tracer feature hole 224 until the tracing fiber 202 butts up against the retention member 306. The user may then open the portion 704 of the opening 506 via pressing down on top of the retention member 306 and inserting the tracing fiber 202 through the portion 704 of the opening 506 to position the tracing fiber 202 in the optical port 304 adjacent to the front surface 116. The user may then stop pressing down on the retention member 306 such that the portion 704 of the opening 506 closes, clamping the tracing fiber 202 between the bottom surface 706 of the finger member 504 and a bottom surface of the opening 506 to capture and hold the tracing fiber 202 in the optical port 304.

### Example Process

FIG. 8 illustrates a flowchart of an illustrative method 800 of identifying a specific network cable within a frame (e.g., frame 104) of a data communication apparatus (e.g., data communication apparatus 100), or another connected frame without accessing a tray (e.g., tray 106). In some embodiments, this process may be performed at a central data communication location, a data center, a central office, a network operations center, a headend location, a point of presence location, a base station, a cell site, an aggregation site, etc. The method 800 may begin at 802 with a user (e.g., user 128) opening an optical cover (e.g., optical cover 228) displaceably attached to the tray disposed in the frame. For example, the user may displace the optical cover from a closed position (e.g., closed position 230) to an open position (e.g., open position 302). The user may displace the optical cover from the closed position to the open position to expose an end (e.g., end 308) of a tracing fiber (e.g., tracing fiber 202) disposed substantially at a centerline (e.g., centerline 310) of an optical port (e.g., optical port 304) and substantially at an end (e.g., end 312) of the optical port.

At 804, the method 800 may include the user positioning a remote lighting device (e.g., remote lighting device 122) with the optical port to visually identify a connection origin of the tracing fiber disposed in the optical. For example, the user may position the remote lighting device such that a ferrule (e.g., ferrule 326) may slide into the optical port. In another example, the user may position the remote lighting device such that one or more guide members (e.g., one or more guide members 402(1) and 402(2)) may slide into one or more guide features (e.g., one or more guide features 404(1) and 404(2)). For example, the user may position the remote lighting device such that the one or more guide members and the one or more guide features cooperate to guide the remote lighting device into position with the optical port.

At 806, the method 800 may include the user inserting the ferrule of the remote lighting device into the optical port, while fitting the tracing fiber into the ferrule. For example, the user may insert the ferrule into the optical port while fitting the tracing fiber into the ferrule and fitting the one or more guide members into the one or more guide features associated with the optical port.

At 808, the method 800 may include the user fitting the one or more guide members into one or more guide features (e.g., one or more guide features 502(1) and 502(2)) arranged in a retention member (e.g., retention member 306). For example, the user may friction fit, press fit, interference fit, etc. the one or more guide members into the one or more guide features arranged in the retention member until the ferrule butts up against the retention member such that the remote lighting device abuts an end (e.g., end 312) of the optical port.

The method 800 may be completed at 810 with the user causing the remote lighting device to project light into the end of the tracing fiber disposed in the optical port to visually identify the connection origin of the tracing fiber disposed in the optical.

### Example Clauses

A. A data communication apparatus comprising: a tray including: a connection management bay sized to accommodate a plurality of multi-fiber cables, at least one multi-fiber cable including: one or more data fibers, and a tracing fiber, a first retaining mechanism configured for holding the one or more data fibers connected via one or more splices or one or more connectors, the first retaining mechanism disposed with the connection management bay, and a second retaining mechanism disposed adjacent to a front surface of the tray, the second retaining mechanism configured for holding the tracing fiber adjacent to the front surface whereat light is receivable and light is projectable from a remote lighting device to visually identify a connection origin of the tracing fiber.

B. The apparatus as paragraph A recites, wherein when the tray is disposed in a frame, the front surface of the tray is disposed proximate to a front surface of the frame.

C. The apparatus as paragraph A or B recites, the frame comprising a door attached to a front portion of the frame, the door including a transparent portion such that the front surface of the tray is visible through the transparent portion to visually identify the connection origin of the tracing fiber.

D. The apparatus as any one of paragraphs A through C recite, wherein the second retaining mechanism includes: a tracing fiber channel, a guide member disposed with the tracing fiber channel, the guide member having a front portion opposite a rear portion, the front portion disposed adjacent to the front surface of the tray and the rear portion disposed adjacent to the tracing fiber channel, the guide member including: a guide wall extending from the rear portion toward the tracing fiber channel, and a guide ramp extending from the rear portion through the guide member to the front portion, wherein the guide wall guides the tracing fiber from the tracing fiber channel into the guide ramp, and an optical port disposed in the front surface of the tray, wherein the optical port is aligned with the guide ramp, and the guide ramp guides the tracing fiber into the optical port whereat light is receivable and light is projectable from the remote lighting device to visually identify the connection origin of the tracing fiber.

E. The apparatus as any one of paragraphs A through D recite, further comprising a retention member disposed between the guide member and the optical port, the retention member for selectively holding the tracing fiber in the optical port.

F. The apparatus as any one of paragraphs A through E recite, further comprising an optical cover disposed in front of the optical port.

G. The apparatus as any one of paragraphs A through F recite, wherein the optical cover includes an optical diffuser.

H. The apparatus as any one of paragraphs A through G recite, wherein the optical cover is displaceably attached to the tray between an open position and a closed position, wherein: when in the open position light is projectable from the remote lighting device into the tracing fiber to visually identify the connection origin of the tracing fiber, and when in the closed position light is projectable from the remote lighting device and into the optical cover to visually identify the connection origin of the tracing fiber.

I. The apparatus as any one of paragraphs A through H recite, further comprising a tracing fiber management bay sized to accommodate a plurality of tracing fibers of the plurality of multi-fiber cables, the tracing fiber management bay configured for storing at least an extra length of the tracing fiber, the extra length of the tracing fiber for adjusting a location of an end of the tracing fiber disposed in the optical port or for cleaving the end of the tracing fiber.

J. The apparatus as any one of paragraphs A through I recite, wherein the remote lighting device includes: an adapter having a front surface opposite a back surface, the adapter including: a port arranged in the front surface configured for holding a fiber optic connector, and a ferrule protruding from the back surface for inserting into the optical port and guiding the tracing fiber into the ferrule to align the tracing fiber with a center of a core of the fiber optic connector.

K. The apparatus as any one of paragraphs A through J recite, wherein: the remote lighting device further includes one or more guide members protruding from the back surface, and the second retaining mechanism further includes one or more guide features arranged with the optical port, wherein the one or more guide members and the one or more guide features cooperate to guide the remote lighting device into position with the optical port such that light is projected from the remote lighting device into the tracing fiber to visually identify the connection origin of the tracing fiber.

L. The apparatus as any one of paragraphs A through K recite, wherein the one or more data fibers comprise single mode fibers or multimode fibers, and the tracing fiber includes a single mode fiber or a multimode fiber.

M. The apparatus as any one of paragraphs A through L recite, wherein the one or more data fibers include at least two single mode fibers or the tracing fiber includes a multimode fiber.

N. A data communication apparatus comprising: a frame having a front side opposite a back side, a tray having a front surface opposite a back surface, the tray removably disposed in the frame such that the front surface of the tray is disposed proximate to the front side of the frame, the tray including: a connection management bay sized to accommodate a plurality of multi-fiber cables, at least one multi-fiber cable including: one or more data fibers, and a tracing fiber, and a retaining mechanism disposed adjacent to the front surface of the tray, the retaining mechanism configured for holding the tracing fiber adjacent to the front surface whereat light is receivable and light is projectable from a remote lighting device to visually identify a connection origin of the tracing fiber.

O. The apparatus as paragraph N recites, wherein the retaining mechanism includes: a tracing fiber channel, a guide member disposed with the tracing fiber channel, the guide member having a front portion opposite a rear portion, the front portion disposed adjacent to the front surface of the tray and the rear portion disposed adjacent to the tracing fiber channel, the guide member including: a guide wall extending from the rear portion toward the tracing fiber channel, and a guide ramp extending from the rear portion through the guide member to the front portion, wherein the guide wall guides the tracing fiber from the tracing fiber channel into the guide ramp, and an optical port disposed in the front surface of the tray, wherein the optical port is aligned with the guide ramp, and the guide ramp guides the tracing fiber into the optical port whereat light is receivable and light is projectable from the remote lighting device to visually identify the connection origin of the tracing fiber.

P. The apparatus as paragraph N or O recties, wherein the retaining mechanism further includes a retention member disposed between the guide member and the optical port, the retention member for selectively holding the tracing fiber in the optical port.

Q. The apparatus as any one of paragraphs N through P recite, further comprising an optical cover disposed in front of the optical port, wherein the optical cover is displaceably attached to the tray between an open position and a closed position, wherein: when in the open position light is projectable from the remote lighting device into the tracing fiber to visually identify the connection origin of the tracing fiber, and when in the closed position light is projectable from the remote lighting device and into the optical cover to visually identify the connection origin of the tracing fiber.

R. A data communication apparatus comprising: a tray including: a connection management bay sized to accommodate a plurality of multi-fiber cables, at least one multi-fiber cable including: one or more data fibers, and a tracing fiber, a retaining mechanism disposed adjacent to a front surface of the tray, the retaining mechanism including an optical port disposed in the front surface of the tray, the retaining mechanism configured for holding the tracing fiber in the optical port whereat light is receivable and light is projectable from a remote lighting device to visually identify a connection origin of the tracing fiber.

S. The apparatus as paragraph R recites, wherein the retaining mechanism further includes: a tracing fiber channel, a guide member disposed with the tracing fiber channel, the guide member having a front portion opposite a rear portion, the front portion disposed adjacent to the front surface of the tray and the rear portion disposed adjacent to the tracing fiber channel, the guide member including: a guide wall extending from the rear portion toward the tracing fiber channel, and a guide ramp extending from the rear portion through the guide member to the front portion, wherein the guide wall guides the tracing fiber from the tracing fiber channel into the guide ramp, and wherein the optical port is aligned with the guide ramp, and the guide ramp guides the tracing fiber into the optical port whereat light is receivable and light is projectable from the remote lighting device to visually identify the connection origin of the tracing fiber.

T. The apparatus as paragraph R or S recites, further comprising a retention member disposed between the guide member and the optical port, the retention member for selectively holding the tracing fiber in the optical port.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A data communication apparatus comprising:
a tray including:
a connection management bay sized to accommodate a plurality of multi-fiber cables, at least one multi-fiber cable including:
one or more data fibers, and
a tracing fiber,
a first retaining mechanism configured for holding the one or more data fibers connected via one or more splices or one or more connectors, the first retaining mechanism disposed with the connection management bay, and
a second retaining mechanism disposed adjacent to a front surface of the tray, the second retaining mechanism configured for holding the tracing fiber adjacent to the front surface whereat light is receivable and light is projectable from a remote lighting device to visually identify a connection origin of the tracing fiber.

2. The apparatus of claim 1, wherein when the tray is disposed in a frame, the front surface of the tray is disposed proximate to a front surface of the frame.

3. The apparatus of claim 2, the frame comprising a door attached to a front portion of the frame, the door including a transparent portion such that the front surface of the tray is visible through the transparent portion to visually identify the connection origin of the tracing fiber.

4. The apparatus of claim 1, wherein the second retaining mechanism includes:
a tracing fiber channel,
a guide member disposed with the tracing fiber channel, the guide member having a front portion opposite a rear portion, the front portion disposed adjacent to the front surface of the tray and the rear portion disposed adjacent to the tracing fiber channel, the guide member including:
a guide wall extending from the rear portion toward the tracing fiber channel, and
a guide ramp extending from the rear portion through the guide member to the front portion,
wherein the guide wall guides the tracing fiber from the tracing fiber channel into the guide ramp, and
an optical port disposed in the front surface of the tray,
wherein the optical port is aligned with the guide ramp, and the guide ramp guides the tracing fiber into the optical port whereat light is receivable and light is projectable from the remote lighting device to visually identify the connection origin of the tracing fiber.

5. The apparatus of claim 4, further comprising a retention member disposed between the guide member and the optical port, the retention member for selectively holding the tracing fiber in the optical port.

6. The apparatus of claim 4, further comprising an optical cover disposed in front of the optical port.

7. The apparatus of claim 6, wherein the optical cover includes an optical diffuser.

8. The apparatus of claim 6, wherein the optical cover is displaceably attached to the tray between an open position and a closed position, wherein:
when in the open position light is projectable from the remote lighting device into the tracing fiber to visually identify the connection origin of the tracing fiber, and
when in the closed position light is projectable from the remote lighting device and into the optical cover to visually identify the connection origin of the tracing fiber.

9. The apparatus of claim 4, further comprising a tracing fiber management bay sized to accommodate a plurality of tracing fibers of the plurality of multi-fiber cables, the tracing fiber management bay configured for storing at least an extra length of the tracing fiber, the extra length of the tracing fiber for adjusting a location of an end of the tracing fiber disposed in the optical port or for cleaving the end of the tracing fiber.

10. The apparatus of claim 4, wherein the remote lighting device includes:
an adapter having a front surface opposite a back surface, the adapter including:
a port arranged in the front surface configured for holding a fiber optic connector, and
a ferrule protruding from the back surface for inserting into the optical port and guiding the tracing fiber into the ferrule to align the tracing fiber with a center of a core of the fiber optic connector.

11. The apparatus of claim 10, wherein:
the remote lighting device further includes one or more guide members protruding from the back surface, and
the second retaining mechanism further includes one or more guide features arranged with the optical port,
wherein the one or more guide members and the one or more guide features cooperate to guide the remote lighting device into position with the optical port such that light is projected from the remote lighting device into the tracing fiber to visually identify the connection origin of the tracing fiber.

12. The apparatus of claim 1, wherein the one or more data fibers comprise single mode fibers or multimode fibers, and the tracing fiber includes a single mode fiber or a multimode fiber.

13. The apparatus of claim 1, wherein the one or more data fibers include at least two single mode fibers or the tracing fiber includes a multimode fiber.

14. A data communication apparatus comprising:
a frame having a front side opposite a back side,
a tray having a front surface opposite a back surface, the tray removably disposed in the frame such that the front surface of the tray is disposed proximate to the front side of the frame, the tray including:
a connection management bay sized to accommodate a plurality of multi-fiber cables, at least one multi-fiber cable including:
one or more data fibers, and
a tracing fiber, and
a retaining mechanism disposed adjacent to the front surface of the tray, the retaining mechanism configured for holding the tracing fiber adjacent to the front surface whereat light is receivable and light is projectable from a remote lighting device to visually identify a connection origin of the tracing fiber.

15. The apparatus of claim 14, wherein the retaining mechanism includes:
a tracing fiber channel,
a guide member disposed with the tracing fiber channel, the guide member having a front portion opposite a rear portion, the front portion disposed adjacent to the front surface of the tray and the rear portion disposed adjacent to the tracing fiber channel, the guide member including:
a guide wall extending from the rear portion toward the tracing fiber channel, and
a guide ramp extending from the rear portion through the guide member to the front portion,
wherein the guide wall guides the tracing fiber from the tracing fiber channel into the guide ramp, and
an optical port disposed in the front surface of the tray,
wherein the optical port is aligned with the guide ramp, and the guide ramp guides the tracing fiber into the optical port whereat light is receivable and light is projectable from the remote lighting device to visually identify the connection origin of the tracing fiber.

16. The apparatus of claim 15, wherein the retaining mechanism further includes a retention member disposed between the guide member and the optical port, the retention member for selectively holding the tracing fiber in the optical port.

17. The apparatus of claim 15, further comprising an optical cover disposed in front of the optical port, wherein the optical cover is displaceably attached to the tray between an open position and a closed position, wherein:
when in the open position light is projectable from the remote lighting device into the tracing fiber to visually identify the connection origin of the tracing fiber, and
when in the closed position light is projectable from the remote lighting device and into the optical cover to visually identify the connection origin of the tracing fiber.

18. A data communication apparatus comprising:
a tray including:
a connection management bay sized to accommodate a plurality of multi-fiber cables, at least one multi-fiber cable including:
one or more data fibers, and
a tracing fiber,
a retaining mechanism disposed adjacent to a front surface of the tray, the retaining mechanism including an optical port disposed in the front surface of the tray, the retaining mechanism configured for holding the tracing fiber in the optical port whereat light is receivable and light is projectable from a remote lighting device to visually identify a connection origin of the tracing fiber.

19. The apparatus of claim 18, wherein the retaining mechanism further includes:
a tracing fiber channel,
a guide member disposed with the tracing fiber channel, the guide member having a front portion opposite a rear portion, the front portion disposed adjacent to the front surface of the tray and the rear portion disposed adjacent to the tracing fiber channel, the guide member including:
a guide wall extending from the rear portion toward the tracing fiber channel, and
a guide ramp extending from the rear portion through the guide member to the front portion,
wherein the guide wall guides the tracing fiber from the tracing fiber channel into the guide ramp, and
wherein the optical port is aligned with the guide ramp, and the guide ramp guides the tracing fiber into the optical port whereat light is receivable and light is projectable from the remote lighting device to visually identify the connection origin of the tracing fiber.

20. The apparatus of claim 19, further comprising a retention member disposed between the guide member and the optical port, the retention member for selectively holding the tracing fiber in the optical port.
